(19) United States
(12) Patent Application Publication
(10) Pub. No.: US 2004/0058298 A1
(43) Pub. Date: Mar. 25, 2004

(54) Self centering endodontic files

(76) Inventors: Dennis Brava, Brooklandville, MD (US); Kenneth Koch, Irvine, CA (US)

Correspondence Address: ALFRED M. WALKER, 225 OLD COUNTRY ROAD, MELVILLE, NY, 11747-2712, US

(21) Appl. No.: 10/667,693

(22) Filed: Sep. 22, 2003

Related U.S. Application Data
(60) Provisional application No. 60/413,398, filed on Sep. 25, 2002.

(51) Int. Cl. A61C 5/02

(52) U.S. Cl. 433/102

(57) ABSTRACT

A tapered self-centering rotating endodontic file includes an annular governor collar, such as, for example, a truncated cone or cylinder, which merges into the handle. The file does not require the use of a radial land trailing a cutting edge of the file. Hence, the rotating file prevents damage from eccentric non-centered movement of file against the inner wall of the canal. The smooth, non-cutting annular governor portion is provided on the file, away from the fluted cutting edges of the file, so that the governor can contact the inner walls of the canal as the cutting edges are cleaning and shaping internal dentinal walls of the canal. Optionally, a set of files includes a first file for initially opening the canal, a second file for canal and a third file for finishing, shaping and cleaning the canal.

### FIELD OF THE INVENTION

The present invention relates to self-centering rotating endodontic files for dental root canal procedures.

### BACKGROUND OF THE INVENTION

When a root canal procedure is being performed, the pulp tissue and bacteria must be removed from the root canal of the tooth. Often the canals are curved, thus necessitating a cleaning file, which can bend as it negotiates further into the canal.

Traditionally, files were hand held instruments having spiral fluting with triangular or square cross sections.

The file was inserted into the canal and moved between the thumb and forefinger in incremental, reciprocating movements.

Later, reciprocating machines, which mimic that hand motion, were used. Now, fully rotational driven hand pieces are used.

Tapered rotating dental endodontic files are used to clean the inside of a root canal in endodontic procedures. Typically these files are tapered fluted bodies, with spiral fluted cutting surfaces providing a working surface for cleaning the conical interior of a root canal.

Also traditionally, the files are twisted or ground before use to create the fluting. Generally, stainless steel files are twisted and nickel titanium files are ground (while clamped), because nickel titanium is superelastic with corresponding shape memory of the alloy, which makes a permanent twist difficult to achieve.

The nomenclature for sets of files is based upon the geometry of the taper of the fluted files. The tapers are defined by the change in width of the fluted cone defining the file. For example, tapers usually vary in increments of the width in parts of millimeters per each increase in lengthwise length of the file.

For example, an “02” file means that for every lengthwise millimeter change in length the width changes 0.02 millimeter. An “04” file means that for every lengthwise millimeter change in length the width changes 0.04 millimeter. An “06” file means that for every lengthwise millimeter change in length the width changes 0.06 millimeter. An “08” file means that for every lengthwise millimeter change in length the width changes 0.08 millimeter.

In the past, the files have been made from stainless steel. Stainless steel files are easy to twist into a fluted configuration and honed to a point. However, the problem with stainless steel is that it lacks shape memory and superelasticity. That is, if bent out of shape, like a paper clip it remains in the bent shape.

More recently, rotary endodontic files are made of nickel titanium, a metal alloy that has shape memory and superelasticity. However, nickel titanium files are hard to twist like stainless steel, because like a rubber band they tend to return to their original shape, and will “untwist.” Therefore, production of nickel titanium files involves isolating the pre-fluted file in a stationary position, where grinding wheels are applied to the file, such as CNC (computer numerically controlled) ROLLAMATIC machines.

Moreover, U.S. Pat. Nos. 5,984,679 and 6,315,558 B1, both of Farzin-Nia et al, describe a new procedure, in which nickel titanium can now be twisted.

A major problem with mechanically rotated endodontic files is that unless there is a non-cutting surface touching opposite portions of the inside of the canal being routed and cleaned by the rotating file, the file will erratically deviate off center within the canal, sometimes damaging or even perforating through the root canal wall, rendering root canal therapy impossible to achieve and the necessity for extraction of the tooth.

For example, if the diameter of the tapered rotating file is less than the diameter of the portion of the tapered root canal where the working surface of the rotating file is being applied, the file may tend to erratically deflect and cause damage to the root canal wall, possibly permanently damaging the tooth.

Attempts to solve this problem include providing rotating endodontic files with a “radial land” following the fluted cutting edge of the endodontic file.

For example, the convex area following the cutting edge is known as the “radial land”, which is defined as a curved surface portion of a file behind the cutting edge, which extends out radially as far as the cutting edge. Variations of radial lands have the trailing end of the land cut back and recessed, hence they are called recessed radial lands.

When viewed in crossection, these radial lands define a sector of a circle, i.e. a portion of the cross sectional circumference, which is the “radial land” or a “circumferential land.” The “land” is followed by a gap, and then there is provided another cutting surface followed by a trailing radial land.

By contacting the previously cut wall of the root canal, these radial lands keep the rotating file centered while the cutting edges engage the dentin on the inside conical surface of the root canal.

If one does not use radial lands, then there is a possibility that the diameter of the fluted file is less distinct than that of the root canal, which will cause sudden erratic movements of the rotating file bit, possibly damaging a tooth.

Because of the consistent intermittent contact of opposite portions of the inner tapered root canal by the file, the file is “centered” in a proper orientation within the canal.

Among related patents defining radial lands include U.S. Pat. Nos. 6,074,209 and 6,106,296, both of Johnson. Johnson '209 further attempts to reduce the locking and abrupt movement of the rotating endodontic file by providing zones of smaller diameters on a fluted working portion of the file, thereby reducing the total contact surface and hopefully reducing the stalling lock and jerking problems associated with torque.

Among related patents include U.S. Pat. No. 4,850,867 and 6,261,099, both of Senia and Wildey. The Senia '867 patent has a non-cutting tip and a non-cutting segment at the opposite end of the tapered fluted working portion, but the non-cutting segment has a smaller diameter than the tapered fluted working portion.

A cylindrical non-cutting shaft is shown in U.S. Pat. 5,762,497 of Heath. It acts solely as a shaft, does not engage the canal wall and therefore cannot help in self centering the file. In contrast to the present invention, Heath '497 requires radial lands for centering the file within the root canal.

However, as noted before, if the diameter of an active cutting region is less than the inner diameter of a root canal being filed by a rotating endodontic file and the non-cutting portion is less than the cutting portion diameter, these files have a tendency to bounce off the inside of the canal and jerk erratically and suddenly sideways, causing trauma and deviating from the path of the root canal itself.

Moreover, U.S. Pat. No. 5,947,730 of Kaldestad also describes a cylindrical non-cutting shaft at the proximal, non-tip end of the file above the fluted working portion therein. Kaldestad '730 also discusses the use of an annular stop in FIG. 3 therein to stop penetration. Furthermore, Kaldestad '730 discusses using a set of three files of sequential taper for preparation of a root canal.

Unlike the present invention, Kaldestad '730 needs radial lands for self centering a file and does not disclose the use of governor collar to self center a file, and as well the fact that all of the files of Kaldestad '730 have a taper greater than 0.06 mm for larger apical preparations.

Furthermore, Kaldestad '730 does not disclose use of a particular set of three files including a first file for opening a root canal, a second file for negotiating and cleaning the root canal and a third shaping file that provides the final taper to the root canal.

### OBJECTS OF THE INVENTION

It is therefore an object of the present invention to provide a self-centering endodontic file, which does not require the use of trailing radial lands following respective cutting edges.

It is also an object of the present invention to provide a set of files which minimizes the number of files needed by a dentist, wherein the files are sequentially organized depending upon the canal size of the patient.

Other objects which become apparent from the following description of the present invention.

### SUMMARY OF THE INVENTION

In keeping with these objects and others which may become apparent, the present invention is a tapered self-centering rotating endodontic file having three contact points, including one non cutting tip at the distal end and two contact points at the top above the fluted cutting file. The top portion is in the form of an annular governor collar, such as, for example, a truncated cone or cylinder, which merges into the handle.

The annular governor collar has a limited height, of between about 1.0 mm to 2.0 mm, to allow a space above the cutting portion for accumulation of debris, which would not be possible with a continuous collar extending up to the handle.

The self-centering endodontic dental file is superelastic for curved tapered intra-canal filing, and it does not require the use of a “radially extending” radial land trailing a cutting edge of the file. Hence, the rotating file of the present invention does not allow abrupt transverse movement of file against the inner wall of the canal.

This self-centering feature is accomplished by providing the smooth, non-cutting annular governor portion on the file, away from the fluted cutting edges of the file. The governor is preferably a small, smooth, truncated cone portion or alternatively a smooth cylinder, which is provided on the file above the fluted portion, so that the governor can contact the inner walls of the canal as the cutting edges are cleaning and shaping internal dentinal walls of the canal.

Unlike the generally triangular cross section of the fluted portion of the file, the smooth governor portion is circular in cross section.

In certain embodiments for a truncated cone or a cylinder, the axis of the governor portion is parallel to and coextensive with the axis of the tapered fluted portion.

In another embodiment, the truncated conical governor collar or the cylindrical collar may be oriented with an axis, which is not coextensive and parallel with the axis of the fluted portion, so that its axis is tilted, i.e., oriented at an angle off of the major axis of the fluted file.

In addition, the self-centering tapered endodontic file is provided with a smooth non-cutting apex, so that during rotation, the file is self centered by the contact of the governor against the two opposite sides of the inner wall of the tapered root canal and thirdly by the contact of the smooth apex of the file with the converged bottom of the root canal.

The invention also includes a color and numerically coordinated visually ergonomic set of groups of three files each for small, medium and large root canals provided with it.

The reason for minimizing the number of files is because each root canal size needs only sequentially a first file for initially drilling into and opening the root canal, a second file for routing out most of the interior of the tapered root canal and a third file for finishing the shaping and cleaning of the root canal.

The proximal tops of the files are identified with indicia such as “A”, “B” or “C” or “1”, “2” or “3”, such as, for a first file A for first enlarging the root canal orifice, a second file B for cleaning most of the interior of the tapered root canal and a third file C for finishing the shaping and cleaning of the root canal.

The files are further color coordinated by aligned, slanted bands at the proximal non-cutting cylindrical ends of the files, wherein further the position of the band upon the top, middle or lower portion of the proximal non-cutting cylindrical ends of the file further defines the applicable order of the file to be used with a predetermined determination that the root canal is small, medium or large.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a side elevation view of a prior art endodontic rotary file;

FIG. 2 is a side elevation view of an endodontic rotary file of this invention (with the apical distal end tip shown separately for convenience) FIG. 3 is a horizontal crossectional sagital view of a non-cutting governor collar thereof, taken along view arrow lines “2-2” of FIG. 2;

FIG. 4 is a horizontal crossectional sagital view of an active cutting region thereof, taken along view arrow lines “3-3” of FIG. 2;

FIG. 5 is a side elevational view of an alternate embodiment of for a rotary endodontic file of this invention ( with the apical distal end tip shown separately for convenience);

FIG. 6 is a tilted crossectional sagital view of a tilted non-cutting governor collar for the rotary endodontic file shown in FIG. 5, taken along view arrow lines “6-6” of FIG. 5;

FIG. 7 is a horizontal crossectional sagital view of the tilted governor collar of the alternate embodiment shown in FIGS. 5 and 6, taken along view arrow lines “7-7” of FIG. 5;

FIG. 8 is a partial side crossectional view of a tooth showing the loose fit of a prior art rotary endodontic file in a root canal thereof;

FIG. 8A is a partial side crossectional view of a tooth showing a tight close fit of a prior art rotary endodontic file, shown working in a root canal;

FIG. 9 is a partial side crossectional view of a tooth showing the tight close fit of the rotary endodontic file of this invention, shown working in a root canal;

FIGS. 10A, 10B and 10C are side elevation views of three different variations of shaft designs as used with endodontic files of this invention;

FIG. 11 is a side elevation detail of an alternate embodiment of the file shown in FIG. 2, wherein the governor is a cylindrical section with non-tapered sides;

FIG. 12 is a side elevation detail of an alternate embodiment of the file shown in FIG. 5 wherein the tilted governor is a cylindrical section with non-tapered sides;

FIG. 13 is a top plan view of a holder annotated with a diagram showing a coordinated organization of sets of files into sets of files organized in overlapping inverted “Y” configurations for enlarging, cleaning and finishing the cleaning of respective root canals;

FIG. 13A is a front elevational view in partial crossection of the area shown in the ellipse “13A” of FIG. 13;

FIG. 14 is a side elevational view of a set of three files for enlarging, cleaning and finishing the cleaning and shaping of respective root canals of a specified size.

### DETAILED DESCRIPTION OF THE INVENTION

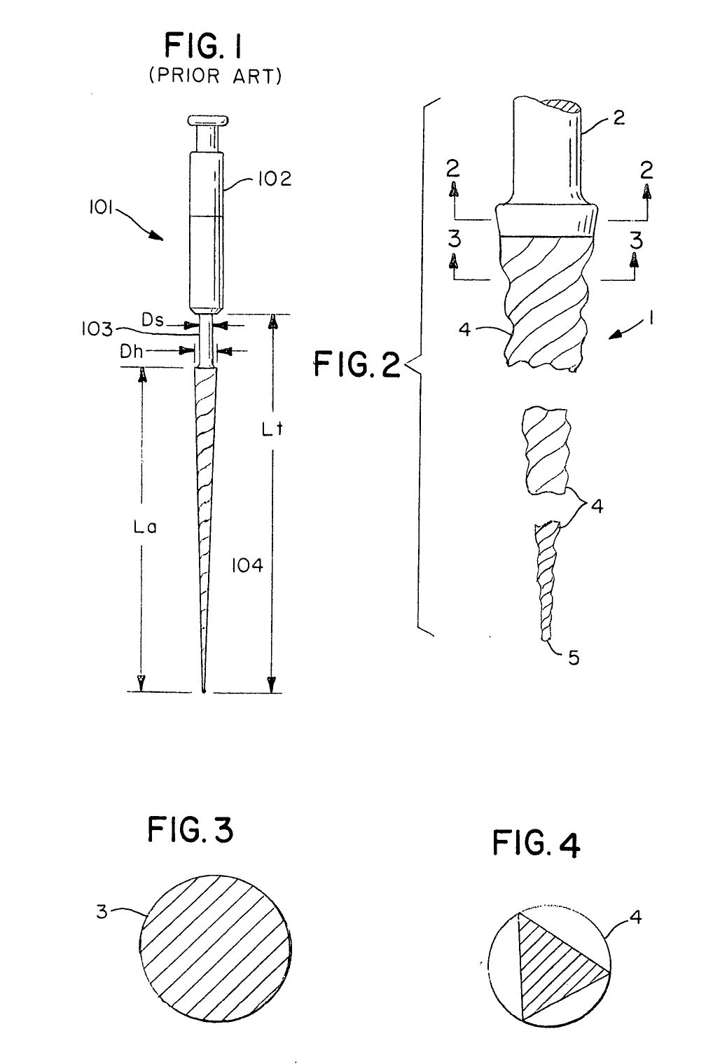

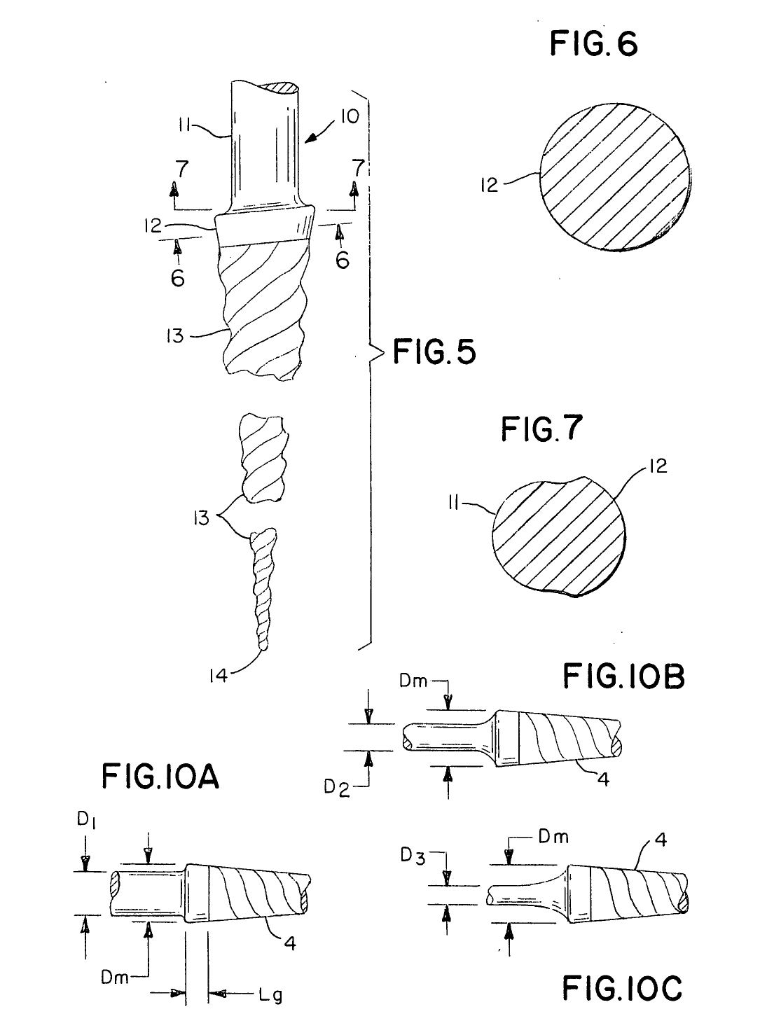

FIG. 1 shows a prior art rotary endodontic file 101 having handle 102, a short cylindrical non-cutting shank 103 and a tapered active cutting region 104 having a length La (typically 16 mm under International Standards Organization (ISO) standards). The combined length of cylindrical non-cutting shank 103 and a tapered active cutting region 104 is shown as length Lt. A cutting or non-cutting tip 105 may also be provided. It is further noted that the diameter Ds is equal to or less than the diameter Dₕ of active cutting region 104, so that the diameter Dₕ of the widest portion of active cutting region 104 is not less than D_{S}.

Therefore, if the diameter Dₕ of the active cutting region 104 is less than the inner diameter of a tooth canal being filed by rotating endodontic file 101, the rotating endodontic file has a tendency to abruptly engage the side of the canal and move erratically and suddenly sideways, causing trauma to the tooth and deviating from the path of the root canal itself.

Some prior art rotary endodontic files are provided with smooth, non-cutting radial land sections following a fluted cutting surface of active cutting region 104 to reduce the tendency to grab in the side of the canal and move erratically and suddenly sideways. However, providing trailing radial land sections upon a fluted cutting surface is difficult to configure and manufacture, as well as reducing overall efficiency of the file.

In contrast, the rotary endodontic file 1 of this invention shown in FIG. 2 has simplified features to minimize or eliminate this problem of the tendency of rotating endodontic files to overly engage the side of the canal and move erratically and suddenly sideways. To solve this problem, a short non-cutting governor collar 3 has been added atop active region 4 and below shaft 2. The governor collar is a tapered or non-tapered collar with respect to the axis of file. It is called a “governor” since it automatically positions the rotary file 1 in the center of the canal in a fashion analogous to the manner in which an engine governor automatically regulates the speed of an engine. A non-cutting tip 5 is also used.

Use of a governor collar applies to a file length where the length of the working surface, (cutting region) is less than that of a standard file having a cutting region length Lₐ of less than 16 mm because the governor collar 3 will keep a shorter file centered better.

Furthermore, while shaft 2 of FIG. 2 is shown merging with the governor collar 3, wherein shaft 2 has a diameter less than the diameter of the governor collar 3, it is known that other configurations can be provided, wherein the diameter of the shaft is equal to the diameter of collar 3 (not shown).

FIG. 3 shows a smooth circular crossection sagital cut of governor collar 2.

FIG. 4 shows a crossection sagital cut of the spiral twisted triangular active cutting region 4.

FIG. 5 shows an alternate embodiment of rotary file 10 of this invention. It differs from that shown in FIG. 2 by virtue of using a tapered but tilted non-cutting governor collar 12 between active region 13 and shaft 11. A non-cutting tip 14 is also used here.

FIG. 6 is a tilted sagital cut view in crossection perpendicular to the axis of collar 12; it is circular.

FIG. 7 is a horizontal sagital cut view in crossection at the junction of shaft 11 and collar 12.

In addition, while shaft 11 is shown merging seamless with governor collar 12, wherein shaft 11 has a diameter less than the diameter of governor collar 12, it is known that other configurations can be provided, wherein the diameter of the shaft 11 is equal to the diameter of collar 12 (not shown), and wherein a distinct seam may be provided between shaft 11 and governor collar 12 (not shown).

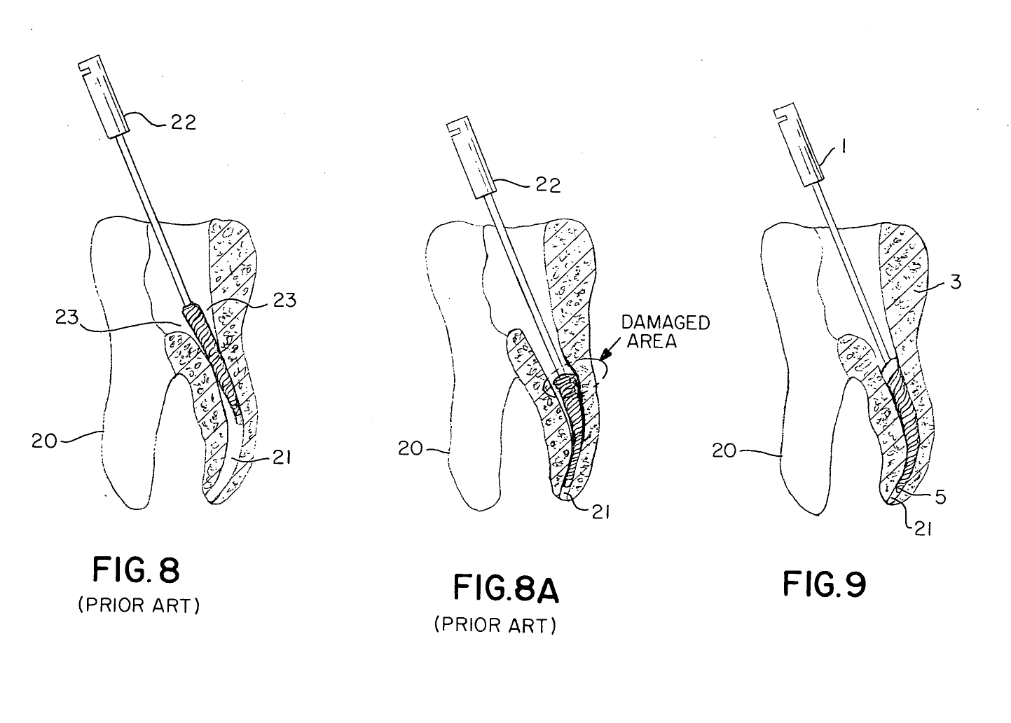

FIGS. 8, 8A and 9 contrast the fit of a prior art endodontic rotary file 22 within root canal 21 of tooth 20 with that of rotary file 1 of this invention. For example, FIG. 8 shows that prior art file 22 has annular space 23 between the top of the root canal and the active fluted region. This is a potential problematic area, which can lead to erratic engagement and eccentric movement of the fluted working surface of rotating endodontic file 22. An unguided lateral (non-centered) movement of endodontic file 22 can cause damage to the wall of tooth 20, possibly perforating tooth 20.

Also, FIG. 8A shows that the tip of file 22 will have difficulty following the distal curvature of canal 21, and therefore file 22 will tend to deviate sideways into the wall of canal 21.

In contrast, according to the present invention shown in FIG. 9, endodontic file 1 has a more conformal tight close fit to canal 21. Governor collar 3, being the widest part above the cutting region smoothly and closely contacts two points of the continuous inner wall of canal 21, which prevents cutting into the side of the top of root canal 21 as opposed to region 23 in FIG. 8. Also, non-cutting tip 5 will more easily follow distal curvature by not cutting into the wall of canal 21.

The combination of governor collar 3 contacting the wall of canal 21 at two points, plus the contact of non cutting tip 5 at the apical end of canal 21, provides a three-point contact of non cutting surfaces of endodontic drill 1 with root canal 21, thereby minimizing the risk of damage to tooth 20 due to lateral non-centered movement of rotating endodontic file 1 against the inner wall of canal 21 of tooth 20.

FIGS. 10A, 10B and 10C show three different variations of shaft designs useful with any of the governor files of this invention. In addition, governor collars are short members wherein length L_{g} is typically 1.0 to 2.0 mm. Just as shaft diameter Dₛ is smaller than maximum active diameter Dₕ in FIG. 1 to promote removal of debris from the root canal, the three shaft variations all have a diameter less than Dₘ which is the maximum diameter of the governor.

In FIG. 10A, shaft diameter D₁ is only slightly smaller than Dₘ.

In FIG. 10B, shaft diameter D₂ is significantly smaller than Dₘ(and therefore more flexible).

In FIG. 10C, shaft diameter D₃ is similar to D₂, but it increases to Dₘ more gradually.

FIG. 11 shows an alternate embodiment using governor 53 which is comparable to governor 3 of FIG. 2 with the exception that governor 53 is now a parallel (cylindrical) section instead of a tapered (conical) section as is governor 3.

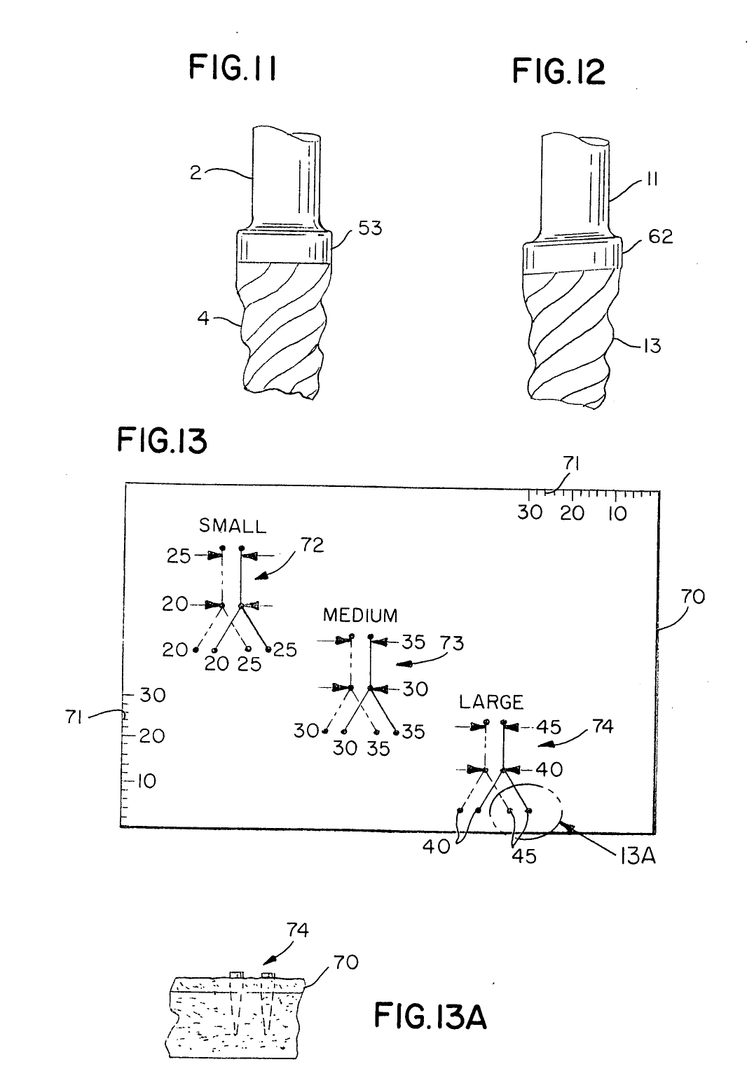

Similarly, FIG. 12 shows an alternate embodiment comparable to governor 12 in FIG. 5 wherein tilted governor 62 is now a parallel (cylindrical) section instead of the tapered (conical) section as in governor 12.

FIG. 13 shows a color and numerically coordinated visually ergonomic grouping of sets of three files, which are provided for each size canal of small, medium and large.

The overlapping inverted “Y” configuration of FIG. 13 refers to the fact that files are either 21 or 25 mm in length. The left most inverted “Y” refers to the 21 mm length files and the right side inverted “Y” refers to the 25 mm length files. The three sets of overlapping inverted “Y”s refer to double sets of small, medium and large canal sizes in terms of width, wherein each set includes alternatively sets of files of 21 or 25 mm in length.

FIG. 13 is actually a top plan view of a holder and organizer 70 for the endodontic files of this invention. It includes an annotated top sheet bonded to a substrate formed of a semi-rigid foam sponge block approximately 30 mm thick.

FIG. 13A is a front crossectional view of a portion of large file set 74 in holder and organizer 70, as depicted in ellipse “13A” of FIG. 13.

The actual files are stored in the foam sponge block by driving the shafts through holes in the top sheet shown as dots in the three inverted “Y” displays marked “SMALL” set 72, “MEDIUM” set 73, and “LARGE” set 74. The millimeter scales 71 are used as a measuring convenience.

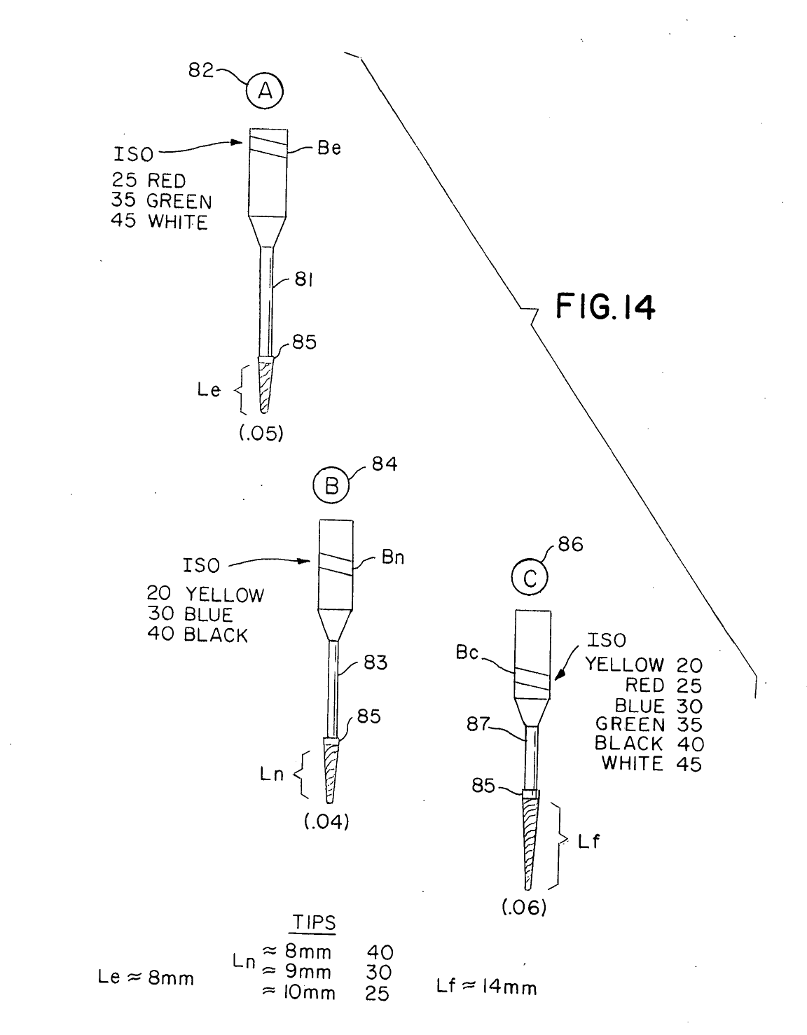

FIG. 14 shows a typical set 80 of three files with indicia “A”, “B” and “C”. The reason for minimizing the number of files to sets of three files A, B and C for a respective root canal is because each root canal size needs only sequentially a first file A for first enlarging the root canal orifice, a second file B for cleaning most of the interior of the tapered root canal and a third file C for finishing the shaping and last cleaning of the root canal.

The proximal tops 82, 84 and 86 of the files are identified with “A”, “B” or “C”.

The preferred taper of the initial file 81 is about 0.05 mm while the preferred length of the active region Le is approximately 8 mm.

The preferred taper for the second file 83 is about 0.04 mm while the length Lₙ of the active region is dependent on the tip as shown in the table in FIG. 14, such as for example, between about 8 to 10 mm.

The preferred taper of the third file 87 is about 0.06 mm while the length of the active region L_{f} is approximately 14 to 16 mm.

As further shown in FIG. 14, endodontic files A, B and C are further color coordinated by slanted, aligned bands Bₑ, Bₙ and B_{f} at the proximal non-cutting cylindrical ends of the respective files 81, 83 and 87, wherein further the position of the respective band Bₑ, Bₙ or B_{f} upon the top, middle or lower portion of the proximal non-cutting cylindrical ends of the respective files 82 (A), 83 (B) or 87 (C) further defines the order of use of each file A, B or C to be used with a predetermined determination that the root canal is small, medium or large.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention.

We claim:

1. A self centering endodontic file comprising:
a shank;
a tapered working portion of said shank terminating in a non cutting tip at a distal end of said shank;
a non-cutting governor collar formed on said shank adjacent to and distinct from said tapered working portion of said shank, said collar having a diameter at least as large as the largest diameter of said tapered working portion; and, said governor collar being adapted to contact an entrance wall of a root canal of a tooth in which said file is to be used in order to help stabilize said file.

2. The endodontic file of claim 1 in which the length of said collar is in the range of 1 to 2 mm.

3. The endodontic file of claim 2 in which said collar is adapted to contact the wall of said opening in at least two places.

4. The endodontic file of claim 3 in which said shank has a reduced diameter on a side of said collar away from said working portion to receive debris.

5. The endodontic file of claim 4 in which the diameter of said collar is greater than the largest diameter of said working portion.

6. The endodontic file of claim 1 in which said collar is circular in cross section.

7. The endodontic file of claim 1 in which said collar is tapered.

8. The endodontic file of claim 7 in which said collar has an axis parallel to an axis of said file.

9. The endodontic file of claim 7 in which said collar is tilted.

10. The endodontic file of claim 4 in which the diameter of said collar is at least equal to the largest diameter of said working portion.

11. The endodontic file of claim 10 in which said collar is cylindrical.

12. The endodontic file of claim 11 in which said collar is tilted.

13. The endodontic file of claim 1 wherein at least one axially extending facet is provided in a surface of said collar to permit transfer of debris from said tapered working portion to a collection region above said collar.

14. The method of stabilizing an endodontic file in a root canal comprising the steps of:
inserting an endodontic file into said root canal, said file comprising a shank, a tapered working portion of said shank terminating in a non cutting tip at a distal end of said shank,
a non-cutting governor collar formed on said shank adjacent to and distinct from said tapered working portion of said shank, said collar having a diameter at least as large as the largest diameter of said tapered working portion;
locating said endodontic file within said root canal such that said collar is in contact with sides of an opening into said root canal in at least two places; and
rotating said endodontic file within said root canal while maintaining contact between said collar and said sides of the opening into said root canal.

15. The method of claim 14 in which said non-cutting tip of said file is maintained in contact with a side wall of said root canal during cutting.

16. A self centering endodontic file comprising:
a shank;
a tapered working portion of said shank terminating in a non cutting tip at a distal end of said shank;
a non-cutting governor collar formed on said shank adjacent to and distinct from said tapered working portion of said shank, said collar having a diameter at least as great as the largest diameter of said tapered working portion and a length in the range of 1 to 2 mm; and
a receptacle behind said collar on a side opposite said working portion formed by a reduced diameter of said shank to receive debris.

17. A holder and organizer for endodontic files comprising:
a file-accommodating material carrier;
said carrier having a plurality of inverted “Y” displays, one for each of small, medium, and large;
each Y display comprising a plurality of overlapping Y's; and
said files being mounted in said holder through holes in said Y's, said overlapping Y's for each of small, medium and large files allowing for files of different canal lengths.

18. The holder and organizer of claim 17 having a metric scale along an edge of said sheet.

19. The holder and organizer of claim 17 further comprising a top sheet covering said file-accommodating material carrier.

20. The holder and organizer of claim 17 wherein said file-accommodating material carrier is a substrate formed of a semi-rigid foam sponge block.

21. A set of endodontic files for treating and cleaning root canals of a tooth comprising:
a set of three files,
a first orifice enlarging file of said set of three files initially enlarging the root canal orifice of a root canal,
a second cleaning file of said set of three files cleaning the interior of a root canal to a pre-determined working length of the root canal, and,
a third shaping and finishing file of said set of three files applying a shaping and finishing to the root canal to said pre-determined working length.

22. The set of endodontic files as in claim 21 further comprising each said file having indicia thereon indicating the identity and function of each said file.

23. The set of endodontic files as in claim 21 wherein said indicia is provided on a top proximal surface of each said file.

24. The set of files as in claim 21 wherein a predetermined taper of said first orifice enlarging file is about 0.05 mm and the length of an active cutting region of said first orifice enlarging file is about 8 mm.

25. The set of files as in claim 21 wherein a predetermined taper of said second cleaning file is about 0.04 mm and the length of an active cutting region of said second cleaning file is between about 8 and 10 mm.

26. The set of files as in claim 21 wherein a predetermined taper of said third shaping and finishing file is about 0.06 mm and the length of an active cutting region of said third shaping and finishing file is about 14 to 16 mm.

27. The set of endodontic files as in claim 21 wherein each said file is color coordinated by slanted, aligned bands at respective proximal non-cutting cylindrical ends of each said file, wherein further the position of each respective band upon the top, middle and lower portions of each said proximal non-cutting cylindrical ends of said respective files further defines the order of use of each file to be used after a predetermined determination that the respective widths of respective root canals is one of being small, medium or large.
